(19) United States
(12) Patent Application Publication
(10) Pub. No.: US 2013/0102271 A1
(43) Pub. Date: Apr. 25, 2013

(54) Instantaneous Event Reporting (IER) remote system_Instantaneous Crime Report(ICR) cell system

(71) Applicants: Frank Stempski, San Jose, CA (US); Michael Edward Stibila, Lake Mary, FL (US)

(72) Inventors: Frank Stempski, San Jose, CA (US); Michael Edward Stibila, Lake Mary, FL (US)

(21) Appl. No.: 13/230,547

(22) Filed: May 14, 2012

Related U.S. Application Data
(60) Provisional application No. 61/488,724, filed on May 21, 2011.

(51) Int. Cl. H04W 4/22

(52) U.S. Cl. CPC H04W 4/22
USPC 455/404.2

(57) ABSTRACT

An instantaneously executable application on a smart phone or mobile device immediately reports an event, such as being attacked by an assailant, to engage help; or a news event that needs instantaneous reporting and recording. When the application is active, the pressing of two buttons on the mobile device instantly triggers the taking and sending of a picture or a video. In addition, the application appends the location, time of day and/or a pre-recorded audio file to the picture/video data and transmits the complete message to a preprogrammed destination or set of destinations. The message can be delivered via text message, email, or any other communication mechanism available on the phone. The message can be carried over any cellular network, the Internet, or both, and may be carried via a cellular link, Wi-Fi Radio, Bluetooth Radio or any other Internet connection including a hard wired Ethernet connection.

### RELATED APPLICATIONS

This application claims priority under 35 U.S.C. §119 to U.S. Provisional Application No. 61/488,724 filed on May 21, 2011, which application is incorporated by reference herein in its entirety.

### SUMMARY

Embodiments of the present invention make novel use of the resources available on all modem smart phones and mobile devices to instantaneously execute an important personal application. With the sequential or simultaneous pressing of two buttons on the mobile device, the application may be immediately activated. For example, upon activation, an instantaneous event reporting/instantaneous crime reporting (“IER/ICR”) application takes a picture or a video, appends the location, the time of day and/or a pre-recorded audio file to the picture/video data and automatically instantaneously transmits the completed message to a preprogrammed destination or set of destinations. The message may be instantaneously delivered via a text message, an email or any other communication mechanism available on the device. The message may be carried over the 3/4G cellular network, the Internet or both. The message is carried over the 3/4G cellular link, via the Wi-Fi Radio, Bluetooth Radio or any other Internet connection, including a hard wired Ethernet connection. In some embodiments, messages may be formatted and sent using any desired protocol and any desired destination, for example to a personal file, a news agency or a law enforcement agency—e.g., when used as a personal defense tool.

Unlike currently available standard camera applications, an IER/ICR system or application according to the present invention may provide for the assembly and transmission of a compiled message to its destination(s) automatically and instantaneously after taking the picture or video. This invention significantly reduces the time it takes to send critical, picture. video, location, time and audio information to the local police, FBI or a third party monitoring service. Time is critical when reporting crime or suspicious activity to the appropriate authorities. It also enables instantaneous live reporting and recording of news events. This application is also easily used for entertainment purposes as well. For example, when vacationing, one can have their family and friends track your activities as you take pictures and videos on your vacation. Any of these applications can benefit from an IER/ICR system implemented in a standard format and protocol acceptable to law enforcement agencies or news agencies.

### BRIEF DESCRIPTION OF THE DRAWINGS

For a better understanding of the nature and objects of the invention, reference should be made to the following detailed description taken in conjunction with the accompanying drawings, in which:

FIG. 1 is a schematic block diagram of a smart phone;

FIG. 2 is a flow chart of an IER/ICR application according to one embodiment of the present invention;

FIG. 3 is a schematic diagram of a user interface according to one embodiment of the invention; and

FIG. 4 is a schematic diagram of an example of an IER/ICR network system according to one embodiment of the invention.

### DETAILED DESCRIPTION

An IER/ICR system may be implemented as a downloadable software application on a modem smart phone, cell phone or other mobile device. Or it could be implemented in the mobile device hardware silicon circuitry or a combination of both hardware and software.

The following describes the downloadable software implementation but a hardware implementation can be derived from the program executable code normally stored in the mobile device programmable memory or removable memory card:

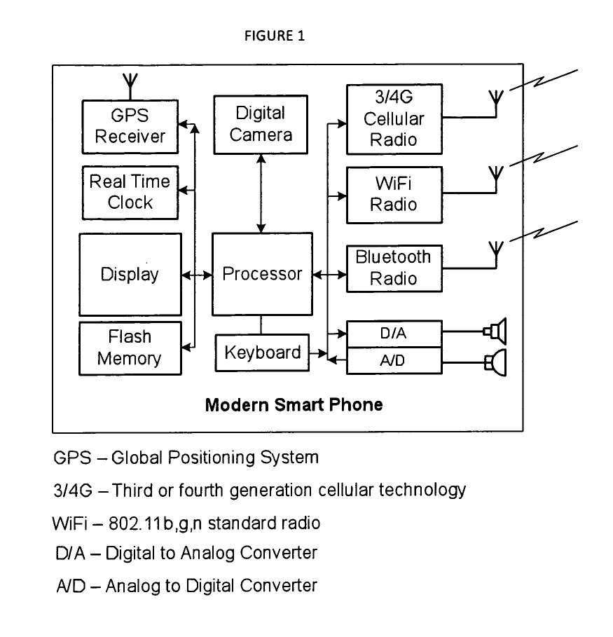

A block diagram of a modern Smart Phone is shown in FIG. 1.

Key elements and their functional descriptions are as follows:

3/4G Cellular Radio -Third or Fourth Generation Cellular Radio used for transmitting voice, video and data over the Wide Area Transmission Network and connecting to the Internet. Long Range, 5 miles or more.

Wi-Fi Radio—IEEE 802.11a,b,g,n Standard Radio used for connection to the Internet. Short Range, up to 250 yards.

Bluetooth Radio—A proprietary, open standard wireless technology standard for exchanging data over short distances, Short Range, 50 to 100 feet.

Digital Camera—A device for converting still pictures or full motion video to digital files for transmission over the digital network.

GPS Receiver—Global Positioning System Receiver that receives signals from several geostationary satellites and is capable of calculating the longitude and latitude of the receiver from the satellite.

Signals. The longitude and latitude accurately determines the location of the device to within 30 feet.

Real Tune Clock—Determines the time of day.

FLASH Memory—Non-Volatile read and write memory technology used to store executable programs, device data and user data.

Processor—Processor, Micro Controller and Digital Signal Processor executes the software program stored in the FLASH Memory providing the logical and signal processing functions required by the Smart Phone.

A/D—Analog to Digital Converter used to convert voice signals to digital form for storage or transmission over the Wide Area Network.

D/A—Digital to Analog converter used to decode digital signals to analog form for connecting to a speaker to create audible signals.

Display—Interactive Video Display for displaying pictures/real time video and converting user signals (screen touches) to device functions.

Keyboard—Keyboard for entering alpha numeric text and converting the text to digital form.

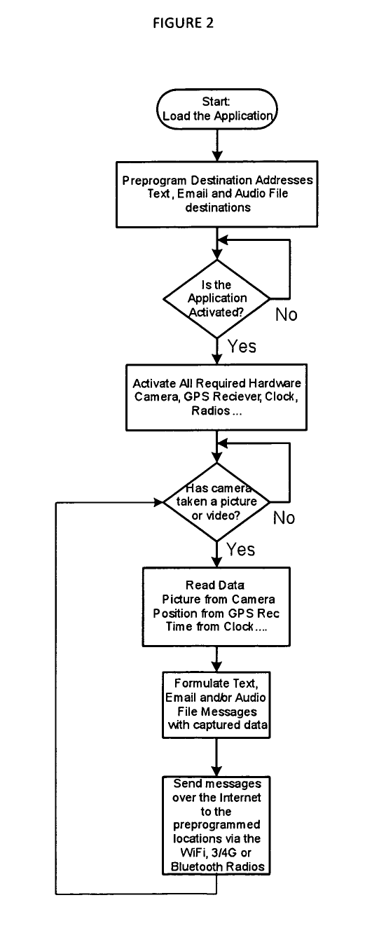

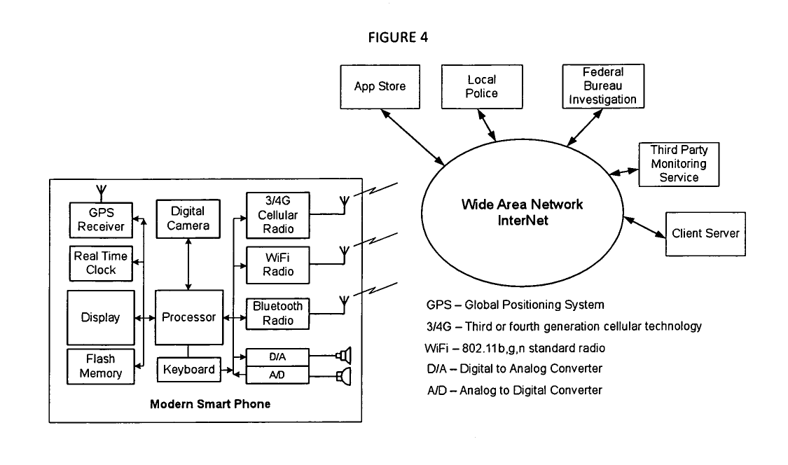

The implementation of the invention is envisioned as a software downloadable executable application (also referred to herein as an “app”). This app is written compiled and stored at a third party applications store connected to the Internet. Users, via their smart/cell phone and Internet, can connect to an App Store and purchase and download the application over the network. See FIG. 4. The application software is loaded and stored in the smart Phone's Flash Memory where it can be read and executed by the Processor. FIG. 2 is a flow chart of the application's executable program.

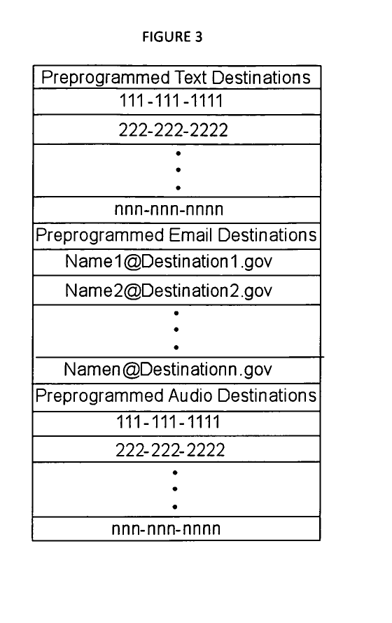

As the flow chart indicates, when the application is started, the user programs the predetermined destinations for the text and email messages automatically generated by the program. The user interface may look like what is shown in FIG. 3.

Once these destination addresses have been programmed and stored, the Application is ready for activation. The App can be activated via the touch screen display or keyboard. Once activated for execution by the MicroController/DSP, the application powers up all necessary hardware and waits for either a picture or video to be taken. Once the picture or video is taken, the MicroController reads the position data from the GPS receiver, the time and date from the real time clock, and the picture/video data from the digital clock. The Microcontroller assembles the complete message and transmits the message over the wide area network or internet to the local police, FBI (Federal Bureau of Investigation) or a third party monitoring service such as ADT or Brinks. See FIG. 4.

All this activity occurs in a fraction of a second after the picture or video is taken. Once the transmission is complete the application returns the state where it waits for another picture or video to be taken.

Unlike currently available standard camera applications and this invention is that the assembly and transmission of the compiled message to its destination(s) is automatic and instantaneous after taking the picture or video. This invention significantly reduces the time it takes to send critical, picture, video, location, time and audio information to the local police, FBI or a third party monitoring service. Time is critical when reporting crime or suspicious activity to the appropriate authorities. It also enables instantaneous live reporting and recording of news events. This application is also easily used for entertainment purposes as well. For example, when vacationing, one can have their family and friends track your activities as you take pictures and videos on your vacation. Any of these application can benefit from this invention application which is implemented in the standard format and protocol acceptable to law enforcement agencies or news agencies.

1-8. (canceled)

9. A method of communicating an event to one or more destination addresses from a mobile device, the method comprising:
receiving an activation instruction; and, in response to the activation instruction, automatically:
capturing a photo or a video using a camera module of the mobile device in response to the activation instruction;
determining a position using a GPS module of the mobile device in response to the activation instruction;
determining a time of activation instruction using a clock mobile of the mobile device;
formulating a message comprising the photo or video, the position, and the time; and
sending the message over a network to a plurality of destination addresses stored in a memory of the mobile device.

10. The method of claim 9, wherein the message is transmitted using any of a cellular radio, a satellite radio, a WiFi radio, or a Bluetooth radio of the mobile device.

11. The method of claim 9, wherein the message is delivered to the plurality of destination addresses by a text message, an email message, an audio message or any combination thereof.

12. The method of claim 9, wherein receiving the activation instruction comprises receiving a signal generated by a user pressing a predetermined combination of buttons on the mobile device.

13. The method of claim 9, further comprising storing the plurality of destination addresses in the memory of the mobile device.

14. The method of claim 13, wherein at least one of the plurality of destination addresses is any of a local police address, a federal bureau of investigations address, or a third party monitory service address.

15. The method of claim 9, wherein the message is sent in a protocol to be used by any of a personal file, a news agency or and law enforcement agency.
